(19) United States
(12) Patent Application Publication
(10) Pub. No.: US 2026/0038478 A1
(43) Pub. Date: Feb. 5, 2026

(54) Gesture Vox

(71) Applicant: Harivatsan Selvam, Alpharetta, GA (US)

(72) Inventor: Harivatsan Selvam, Alpharetta, GA (US)

(21) Appl. No.: 18/793,807

(22) Filed: Aug. 3, 2024

(51) Int. Cl. G10L 13/027; G06V 40/20

(52) U.S. Cl. CPC G10L 13/027; G06V 40/28

(57) ABSTRACT

GestureVox is an innovative AI-powered software system designed to convert sign language into spoken words in real-time. Utilizing advanced machine learning techniques, including frameworks such as TensorFlow, PyTorch, Keras, and Scikit-learn, GestureVox offers a seamless and accurate gesture recognition and speech synthesis process. The system's architecture includes modules for data collection, pre-processing, model training, testing, hyperparameter tuning, and deployment. Key features include the ability to process live video feeds, a user-friendly interface, and scalability to handle a large number of concurrent users, potentially utilizing cloud services such as AWS, Azure, and Google Cloud. GestureVox significantly enhances communication for individuals with speech impairments, providing an inclusive and accessible solution.

### BACKGROUND OF THE INVENTION

This invention pertains to computer science, focusing on machine learning and software systems for gesture recognition and speech synthesis. Specifically, it relates to a software system that converts sign language into spoken words in real-time. Effective communication is essential, yet millions worldwide face barriers due to speech impairments. According to Statistics, approximately 300 million individuals globally are affected by hearing and speech impairments. These individuals often rely on sign language, which creates a communication gap with those who do not understand it, leading to social isolation and limited opportunities for interaction in various social, educational, and professional settings. Current systems are not user-friendly for people with impairments and do not offer specialized services tailored to their needs. Many existing solutions lack the necessary accuracy, speed, and comprehensiveness required to be effective communication tools. This invention seeks to overcome these limitations by providing an AI-powered software system, GestureVox, which offers seamless, real-time conversion of sign language into spoken words. GestureVox ensures accurate, fast, and comprehensive communication support for users, making interactions more inclusive and accessible.

### SUMMARY OF THE INVENTION

GestureVox is an AI-powered software system that converts sign language into spoken words in real-time, addressing communication barriers for individuals with speech impairments. By leveraging advanced machine learning algorithms and gesture recognition technology, GestureVox ensures accurate and rapid conversion of gestures into natural-sounding speech.

The primary objective of GestureVox is to bridge the communication gap between the deaf and hearing communities, making interactions more inclusive and accessible. GestureVox is user-friendly and versatile, suitable for educational settings, workplaces, and daily interactions. It aims to overcome the limitations of current systems by providing a reliable, efficient, and comprehensive communication tool, improving the quality of life for individuals with speech impairments.

### BRIEF DESCRIPTION FOR DRAWINGS

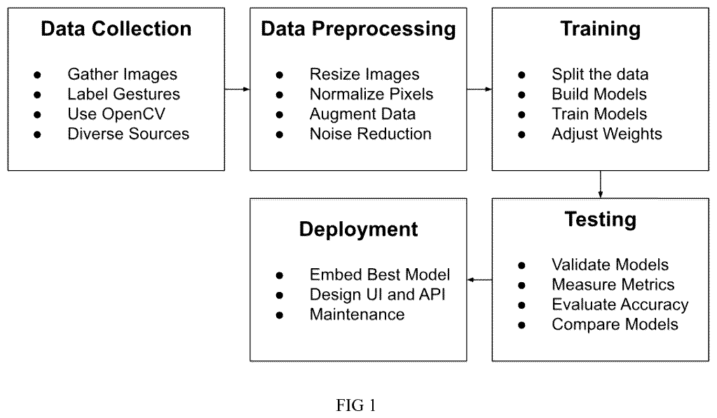

FIG. 1: System Overview of GestureVox
Description: A flowchart providing a high-level overview of the GestureVox system, illustrating its main components and their interactions from data collection to deployment.

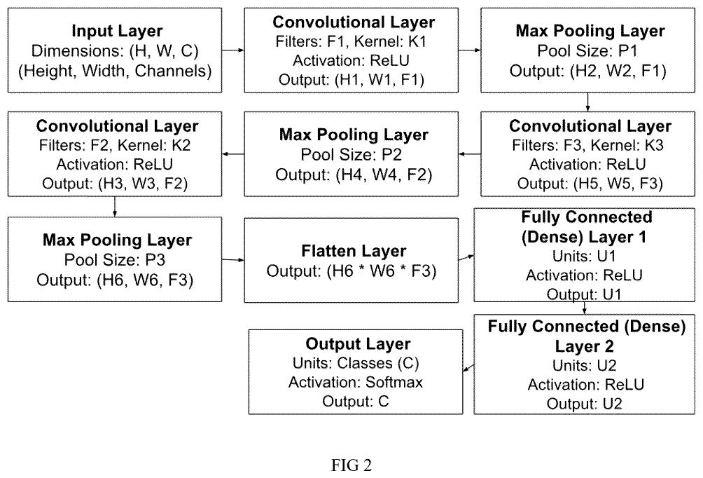

FIG. 2: Neural Network Architecture
Description: A flowchart explaining the neural network architecture, detailing the layers and processes involved in transforming input images into gesture classifications.

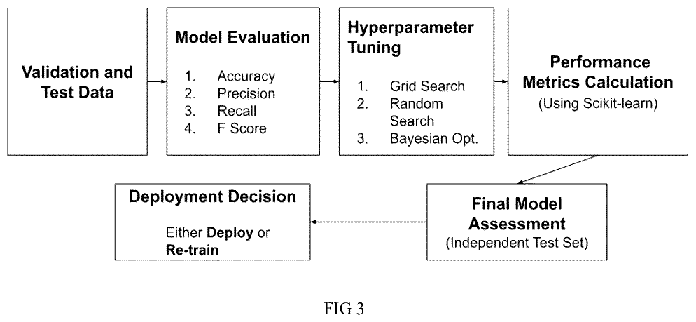

FIG. 3: Evaluation, Testing, and Validation Process
Description: A flowchart detailing the evaluation, testing, and validation process, including performance metric calculations and hyperparameter tuning.

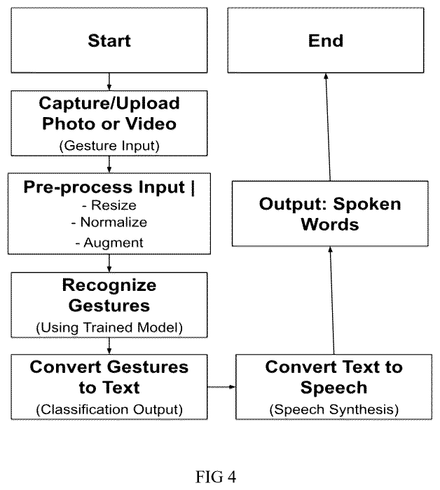

FIG. 4: Overall Functioning of the Software
Description: A flowchart explaining the overall functioning of GestureVox, from user input through gesture recognition to speech synthesis and delivery.

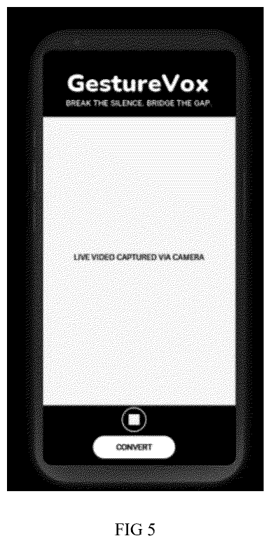

FIG. 5: Sample User Interface of the App
Description: A sample design of the GestureVox user interface, illustrating how users interact with the application for gesture input and speech output.

### DETAILED DESCRIPTION OF THE INVENTION

The present invention relates to an advanced AI-powered software system designed to convert sign language into spoken words in real-time. The system is composed of several key modules: Data Collection, Pre-Processing, Training, Testing, and Deployment. Each module is crucial for ensuring the software's effectiveness and reliability.

The data collection module gathers a comprehensive dataset of images representing common gestures used in sign language. Data is collected from diverse sources to ensure variability, including video recordings of sign language interpreters, crowdsourced images from volunteers fluent in sign language, and publicly available datasets. Each image is meticulously labeled with the corresponding gesture to facilitate supervised learning. Tools such as Python scripts and the OpenCV library are used to capture and label the images, ensuring that the dataset is comprehensive and varied. This comprehensive data collection process ensures that the model is trained on a diverse set of gestures, enhancing its ability to generalize to new, unseen gestures.

Once collected, the data undergoes a series of pre-processing steps to enhance the quality and consistency of the input images. The pre-processing module performs several tasks to standardize the images, including resizing all images to a uniform size suitable for model input, normalizing pixel values to a standard range to improve model convergence, and applying augmentation techniques such as rotation, flipping, and scaling to artificially expand the dataset and improve model generalization. Additionally, noise reduction techniques are employed to remove any background noise or irrelevant details, ensuring that the focus remains on the gesture itself. Libraries like TensorFlow and Keras, along with Python's NumPy and Pandas for data manipulation, are utilized in this module. These pre-processing steps are crucial for ensuring that the images fed into the machine learning models are clean and standardized, which is essential for effective training.

The core of GestureVox's functionality lies in its machine learning model, which is trained to recognize and interpret sign language gestures. The training module involves selecting an appropriate deep learning architecture, such as convolutional neural networks (CNNs), for image recognition tasks. Frameworks like TensorFlow, PyTorch, and Scikit-learn are used for building and training the models. The dataset is divided into training, validation, and test sets to evaluate the model's performance and avoid overfitting.

The neural network for GestureVox is designed to recognize gestures in images through a series of steps. First, the input layer receives the raw image data, maintaining its height, width, and color channels. Convolutional layers then apply filters to the image, creating feature maps that detect edges, textures, and other patterns. These layers use activation functions like ReLU to help the network learn complex features. Next, pooling layers, usually max pooling, reduces the size of the feature maps by selecting the most important values, which helps the network focus on significant features and reduces the amount of data to process. After this, the network flattens the feature maps into a single, one-dimensional vector. This flattened data is passed to fully connected layers, where every neuron is connected to every neuron in the previous layer. These layers combine the learned features to make sense of the patterns and classify the gestures. The final layer uses a softmax activation function to output probabilities for each gesture class. The class with the highest probability is chosen as the predicted gesture. This step-by-step process is intended to enable the neural network to efficiently learn and recognize patterns in images, making it effective for real-time gesture recognition.

During the training process, the pre-processed images are fed into the model, which adjusts its weights based on the error rate, iterating through multiple epochs to optimize performance. The cross-entropy loss function measures the model's accuracy and guides the optimization process, while optimization algorithms like Adam and Stochastic Gradient Descent (SGD) minimize the loss function. This rigorous training process ensures that the model learns to accurately recognize gestures from a wide range of inputs.

After training, the model is rigorously tested to evaluate its accuracy and reliability. The testing module involves assessing the model on the validation set to fine-tune hyperparameters and improve performance, and measuring the final accuracy on an independent test set to ensure robustness and generalizability. Performance metrics such as accuracy, precision, recall, and F1-score are calculated to quantify the model's effectiveness. Python libraries like Scikit-learn are employed for these evaluations. This thorough testing process ensures that the model performs well across a variety of test cases and is robust to different input conditions.

Hyperparameter tuning is critical for optimizing the model's performance. This module involves identifying key hyperparameters such as learning rate, batch size, and number of layers, and applying techniques like grid search, random search, or Bayesian optimization to find the best combination of hyperparameters. Cross-validation is used to validate the effectiveness of the selected hyperparameters and avoid overfitting. Tools like Scikit-learn and Optuna are utilized for hyperparameter tuning. This process ensures that the model operates at its highest possible performance, making it as accurate and reliable as possible.

Multiple models are built and tested during the development process. Their performance is compared based on the results obtained from the testing module. The model with the highest accuracy and best overall performance metrics is selected for deployment. This comparison ensures that GestureVox uses the most effective model for real-time gesture recognition and speech synthesis.

Once the best model is selected, it is deployed for real-time use. The deployment module encompasses embedding the trained model into the GestureVox software application, ensuring the system can process live video feeds and convert gestures to speech in real-time, and designing an intuitive interface that allows users to interact with the software easily. The system is designed to handle a large number of concurrent users and scale efficiently, with continuous monitoring to maintain high accuracy and reliability. Deployment frameworks such as TensorFlow Serving, Flask for the API, and Docker for containerization are used to ensure scalability and ease of deployment.

The user interface is developed using web technologies like HTML, CSS, and JavaScript, possibly utilizing front-end frameworks like React or Angular for a more dynamic experience. This deployment process ensures that the system is powerful, scalable, and user-friendly.

To use GestureVox, users need to install the software application on their device. Upon launching the application, the user interface guides them through the setup process, including camera calibration and initial gesture recognition tests. Once set up, users can perform sign language gestures in front of the camera, and the software processes these gestures in real-time, converting them into spoken words. This seamless interaction allows individuals with speech impairments to communicate effectively with those who do not understand sign language.

GestureVox leverages advanced AI and machine learning techniques to provide a seamless, real-time conversion of sign language into spoken words. By meticulously developing each module from data collection to deployment, GestureVox ensures an accurate and user-friendly solution that bridges the communication gap between the deaf and hearing communities.

GestureVox is designed with flexibility and scalability to evolve in order to improve its accuracy, user experience, and overall power. This description outlines the intended functionality and structure, while accommodating future changes and advancements. Various libraries and frameworks such as TensorFlow, PyTorch, Scikit-learn, Keras, and OpenCV can be employed. Additional tools and services like AWS SageMaker, Google Cloud AI Platform, and Microsoft Azure Machine Learning can be used for model training, testing, and deployment. This strategic approach ensures adaptability while securing patent protection for the core concepts and innovations of GestureVox.

1. A software system for converting sign language gestures into spoken words in real-time, comprising: a data collection module, a pre-processing module, a machine learning model, a training module, a testing module, a hyperparameter tuning module, and a deployment module.

2. The software system of claim 1, wherein the data collection module utilizes tools such as Python scripts and OpenCV for capturing and labeling images.

3. The software system of claim 1, wherein the pre-processing module utilizes libraries such as TensorFlow, Keras, PyTorch, OpenCV, NumPy, and Pandas for data manipulation and augmentation.

4. The software system of claim 1, wherein the training module uses machine learning frameworks such as TensorFlow, PyTorch, Keras, and Scikit-learn to train the machine learning model.

5. The software system of claim 1, wherein the training module uses a loss function, such as cross-entropy loss, to measure the model's accuracy and guide the optimization process.

6. The software system of claim 1, wherein the testing module employs libraries such as Scikit-learn, TensorFlow, and PyTorch to calculate performance metrics.

7. The software system of claim 1, wherein the hyperparameter tuning module uses tools such as Scikit-learn, Optuna, and Hyperopt for hyperparameter optimization.

8. The software system of claim 1, wherein the deployment module utilizes tools such as TensorFlow Serving, Flask, FastAPI, Docker, and Kubernetes to ensure scalability and ease of deployment.

9. The software system of claim 1, wherein the user interface is developed using web technologies such as HTML, CSS, and JavaScript, and may utilize front-end frameworks like React, Angular, and Vue.js.

10. The software system of claim 1, further comprising a user setup process that includes camera calibration and initial gesture recognition tests guided by the user interface.

11. The software system of claim 1, wherein the system is designed to handle a large number of concurrent users and includes continuous monitoring to maintain high accuracy and reliability, potentially utilizing cloud services such as AWS, Azure, and Google Cloud.
